(19) United States
(12) Patent Application Publication
(10) Pub. No.: US 2006/0030342 A1
(43) Pub. Date: Feb. 9, 2006

(54) Method for transmitting and receiving control information in a mobile communication system supporting multimedia broadcast/multicast service

(75) Inventors: Sung-Oh Hwang, Yongin-si (KR); Himke Van Dervelde, Staines (GB); Gert-Jan Van Lieshout, Staines (GB)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/108,537

(22) Filed: Apr. 18, 2005

(30) Foreign Application Priority Data
Apr. 16, 2004 (KR) 2004-26266

(51) Int. Cl. H04B 7/005; H04Q 7/20

(52) U.S. Cl. 455/466; 455/414.1

(57) ABSTRACT

Disclosed is a method for efficiently transmitting and receiving control information messages necessary for a Multimedia Broadcast/Multicast Service (MBMS) provided in a mobile communication system. The method includes setting information elements for the control information messages to reduce unnecessary signaling overhead during the transmission of the control information. The method prevents a user equipment (UE) from performing duplicate reception on the control information, thereby reducing power consumption of a battery.

### PRIORITY

This application claims priority under 35 U.S.C. § 119 to an application entitled “Method for Transmitting and Receiving Control Information in a Mobile Communication System Supporting Multimedia Broadcast/Multicast Service” filed in the Korean Intellectual Property Office on Apr. 16, 2004 and assigned Serial No. 2004-26266, the contents of which are incorporated herein by reference.

### BACKGROUND OF THE INVENTION

1. Field of the Invention

The present invention relates generally to a mobile communication system supporting a Multimedia Broadcast/Multicast Service (MBMS), and in particular, to a method for efficiently transmitting control information for an MBMS service.

2. Description of the Related Art

As the communication technology develops, a service provided in a mobile communication system is evolving into a multimedia broadcast/communication service capable of supporting not only the conventional voice service but also a packet service and a multimedia service to enable the transmission of large amounts bulk data such as packet data and circuit data. In order to support the multicast broadcast/communication, there has been proposed a Multimedia Broadcast/Multicast Service (hereinafter referred to as an “MBMS service”) in which one or more multimedia data sources provide a service to a plurality of user equipments (UEs).

The MBMS service can transmit the same multimedia data to a plurality of recipients through a wireless network. The MBMS service can save wireless transmission resources by allowing a plurality of recipients to share one radio channel. The MBMS service supports the transmission of such multimedia data as real-time image and voice, still image, text, etc., and can simultaneously transmit voice data and image data based on a transfer mode of the multimedia data. This requires a large amount of transmission resources. In the MBMS service, because the same data should transmitted to a plurality of cells where users are located, point-to-point (PtP) connection or point-to-multipoint (PtM) connection is achieved according to the number of users located in each cell. The PtP connection allocates a dedicated channel to each UE and provides a desired MBMS service to the UE through the dedicated channel on an individual basis. However, the PtM connection allocates a common channel to multiple UEs requesting the same MBMS service and provides the MBMS service to the UEs through the common channel.

The following description will be made with reference to a 3^{rd} Generation Partnership Project (3GPP) mobile communication network, which is a typical 3^{rd} generation asynchronous mobile communication network.

FIG. 1 is a diagram illustrating an MBMS service in a 3GPP mobile communication network. Referring to FIG. 1, a core network (CN) 100 provides the MBMS service, the MBMS data transmission, to a UMTS Terrestrial Radio Access Network (UTRAN) 110, and authenticates the UEs 120, 121 and 122. The UTRAN 110 connects the CN 100 to the UEs 120, 121 and 122, and performs wire/wireless resource allocation and management to enable the transmission of the MBMS service. The UTRAN 110 is comprised of at least one radio network controller (RNC) 111 and at least one Node B 112. The RNC 111 can control a plurality of Node Bs. Node B 112 can represent a plurality of Node Bs. The plurality of Node Bs including the Node B 112 each comprise of a plurality of cells. The cell refers to a basic communication unit are in a wireless communication network, and the cells can be identified by their unique frequencies or locations.

The UE#1 120, the UE#2 121 and the UE#n 122 are UEs capable of receiving the MBMS service, and a plurality of UEs can be located in each cell. A basic service unit for the MBMS service is the cell, and the MBMS service is provided through a PtP channel or a PtM channel based on the radio environment of the cell and the number of UEs desiring to receive the MBMS service located in the cell. A counting process to determine the number of UEs is performed to determine which type of MBMS service is preferred.

In order to provide the MBMS service, a plurality of control information messages are transmitted, which include not only data for the MBMS service, but also information on the MBMS service, information on a channel over which the MBMS data is transmitted, information indicating a start time of the MBMS service, information on a change in transfer mode during transmission of the MBMS data, information on neighbor cells, if any, where the MBMS service is provided, and information on an MBMS service provided in the current cell.

FIG. 2 is a diagram illustrating a detailed structure of upper layers of a UTRAN and channels between the respective layers, defined in the current 3GPP, to which the present invention is applied. Referring to FIG. 2, upper layer messages processed in the UTRAN can be roughly divided into signaling and user data.

Disclosed herein are control plain (C-Plain) signaling 201 and User plain (U-Plain) information 202. The C-Plain signaling 201 and the U-Plain information 202 are Non-Access Stratum (NAS) messages, which the UTRAN is not required to know because they are not used for wireless connection between a UE and the UTRAN. Unlike the NAS messages, messages directly used for the wireless connection between the UTRAN and the UE are called Access Stratum (AS) messages, and the AS messages indicate signaling used under a radio resource controller (RRC) 203.

The RRC 203 controls a physical layer (L1) 210, and a Medium Access Control (L2/MAC) 208, a Radio Link Control (L2/RLC) 206, a Packet Data Convergency Protocol (L2/PDCP) 204, and a Broadcast/Multicast Control (L2/BMC) 205 for Layer 2 (L2), all of which are related to an access to a UE and a UTRAN, to control all of the events related to a connection between the UE and the UTRAN. These include physical call setup, logical call setup, control information transmission/reception, and measurement data transmission/reception between the UE and the UTRAN.

The L2/PDCP 204 receives the U-Plain information 202 of a NAS layer, processes the received U-Plain information 202 using an appropriate protocol, and transmits the processing result to the L2/RLC 206. The L2/BMC 205 receives the data needed for the broadcast/multicast, processes the received data using an appropriate protocol, and transmits the processing result to the L2/RLC 206.

The L2/RLC 206 receives a control message output from the RRC 203, processes the received control message in an appropriate format in an RLC#1 261 and an RLC#2 262 taking a feature of the control message into consideration, and transmits the processing result to the L2/MAC 208 using logical channels 207. Further, the L2/RLC 206 receives data from the L2/PDCP 204 and the L2/BMC 205, processes the received data in an appropriate format in an RLC#1 263 and an RLC#n 264, and transmits the processing result to the L2/MAC 208 using the logical channels 207. The number of RLC entities (261 to 264) included in the L2/RLC 206 is determined according to the number of types of the logical channels 207 and the number of radio links.

The logical channels 207 are roughly divided into a dedicated type and a common type according to whether they are for a specified UE(s) or for a plurality of UEs, and into a control type and a traffic type according to a feature of a message transmitted therethrough.

Table 1 illustrates types and functions of the logical channels 207 used in the 3GPP standard.

TABLE 1

| Type | Function |
|---|---|
| BCCH | It stands for a Broadcast Control Channel, and is used for |
| | downlink transmission from a UTRAN to a UE and for |
| | transmission of UTRAN system control information. |
| PCCH | It stands for a Paging Control Channel, and is used for downlink |
| | transmission from a UTRAN to a UE, and for transmission of |
| | control information to the UE when a position of a cell to which |
| | the UE belongs is unknown. |
| CCCH | It stands for a Common Control Channel, and is used for |
| | transmission of control information between a UE and a |
| | network. |
| DCCH | It stands for a Dedicated Control Channel, and is used for |
| | transmission of control information between a UE and a network |
| | on a one-to-one basis. Also, it is used when the UE has a |
| | channel connected to an RRC layer. |
| CTCH | It stands for a Common Traffic Channel, and is used for data |
| | transmission between a network and UEs. Also, it is used when |
| | data that should be transmitted by all of the UEs is transmitted |
| | or when information needed by several UEs is transmitted on a |
| | time-division basis. |
| DTCH | It stands for a Dedicated Traffic Channel, and is used for data |
| | transmission between a network and a UE on a one-to-one basis. |

The L2/MAC 208, under the control of the RRC 203, manages radio resources between a UE and a UTRAN, manages a connection between the UE and the UTRAN, or maps data received from the L2/RLC 206 through logical channels to transport channels 209, and transmits the mapping result to the L1 layer 210.

Table 2 illustrates types and functions of the transport channels 209 used in the 3GPP standard and a mapping relation with the logical channels 207.

TABLE 2

| Type | Function |
|---|---|
| BCH | It stands for a Broadcast Channel, and is mapped to BCCH |
| | to transmit data on the BCCH. |
| PCH | It stands for a Paging Channel, and is mapped to PCCH to |
| | transmit data on the PCCH. |
| RACH | It stands for a Random Access Channel, and is used for |
| | transmission from a UE to a network and for |
| | transmission of network access, a control message |
| | and short-length data. It can be accessed at a predetermined |
| | acquisition probability, and DCCH, CCCH and DTCH |
| | can be mapped to this channel. |
| FACH | It stands for a Forward Access Channel, and is used for control |
| | message and data transmission from a network to a particular |
| | UE or particular UEs. BCCH, CTCH, CCCH, DTCH |
| | and DCCH can be mapped to this channel. |
| DCH | It stands for a Dedicated Channel, and is used for transmission |
| | of data and control signaling between a network and a UE. |
| DSCH | It stands for a Downlink Shared Channel, and is a downlink |
| | channel from a network to a UE, used for high-capacity |
| | data transmission. DTCH and DCCH are mapped to this |
| | channel. |
| HS- | It stands for a High Speed DSCH (Dedicated Shared Channel), |
| DSCH | and is a downlink channel from a network to a UE, |
| | obtained by improving transmission capacity of the DSCH. |
| | DTCH and DCCH are mapped to this channel. |

Aside from the transport channels described in Table 2, such transport channels as an uplink shared channel (USCH) and a common packet channel (CPCH) are defined in the current 3GPP.

As illustrated, data on the transport channels transmitted to the L1 layer 210 is mapped to physical channels through an appropriate process, and then transmitted to a UE or a UTRAN.

The physical channels include a Primary Common Control Physical Channel (P-CCPCH) for the transmission of a BCH, a Secondary Common Control Physical Channel (S-CCPCH) for the transmission of a PCH and a FACH, a Dedicated Physical Channel (DCH) for the transmission of a DCH, a Physical Downlink Shared Channel (PDSCH) for the transmission of a DSCH, a High Speed Physical Downlink Shared Channel (HS-PDSCH) for the transmission of a HS-DSCH, and a Physical Random Access Channel (PRACH) for the transmission of a RACH. In addition, the physical channels include a Pilot Channel, a Primary Synchronization Channel, a Secondary Synchronization Channel, a Paging Indicator Channel, an Acquisition Indicator Channel, and a Physical Common Packet Channel.

Aside from the foregoing logical channels, logical channels for supporting an MBMS service are defined in the 3GPP. The newly defined logical channels include an MBMS Traffic Channel (MTCH) over which MBMS data is transmitted for the MBMS service, and an MBMS Control Channel (MCCH) over which control information needed for reception of the MBMS service is transmitted. The two logical channels are mapped to the FACH which is a transport channel, and then transmitted to UEs scheduled to receive the MBMS service, through the S-CCPCH which is a physical channel.

The “control information” refers to (i) information on a transmission start and a transmission end of MBMS data, and a logical channel, a transport channel and a physical channel, over all of which MBMS data is transmitted, (ii) information on neighbor cells in which the same MBMS is provided, and (iii) information on MBMS services provided in the current cell. Information elements (IEs) needed for the control information messages can be separately defined for each individual message. The messages may overlap each other in terms of the IEs defined for each individual message.

### SUMMARY OF THE INVENTION

In order to prevent the unnecessary overlapping of the IEs, there is a demand for a method to precisely define the IEs needed for each control information message and appropriately arrange the IEs according to a use of the control information messages. In addition, the number of the control information messages increases the amount of control information that a UE should receive for reception of an MBMS service and causes generation of periodically repeated control information messages to support mobility of the UE, a demand for preventing the duplicate reception of the IEs of the control information messages is required. Furthermore, there is a demand for a method that is capable of minimizing a reception time for which the UE receives the control information messages.

It is, therefore, an object of the present invention to provide a method for transmitting and receiving control information messages needed for an MBMS service.

It is another object of the present invention to provide a method for minimizing the signaling overhead in the process of transmitting control information messages for an MBMS service.

It is another object of the present invention to provide an efficient scheduling method for the transmission of control information messages for an MBMS service.

It is further another object of the present invention to provide a method for preventing the duplicate reception of control IEs having the same contents in the process of receiving control information messages for an MBMS service.

It is still another object of the present invention to provide a method for minimizing the power consumption of a UE in the process of receiving control information messages for an MBMS service.

According to one aspect of the present invention, there is provided a method for transmitting control information for supporting a Multimedia Broadcast/Multicast Service (MBMS) service in a mobile communication system providing the MBMS service, the method including the steps of generating an MBMS notification information message indicating a significant change in an MBMS service; and transmitting the MBMS notification information message to at least one user equipment (UE) located in a cell capable of providing the MBMS service; wherein the MBMS notification information message includes an MBMS service identifier (ID), a cause value indicating the cause for the notification, frequency information for the MBMS service, and continue reading information indicating whether to continuously receive control information messages transmitted after the MBMS notification information message.

According to another aspect of the present invention, there is provided a method for receiving control information for supporting a Multimedia Broadcast/Multicast Service (MBMS) service in a mobile communication system providing the MBMS service, the method including the steps of receiving a notification indicator (NI) for an MBMS service; if the received notification indicator is affirmative, determining if a current frame corresponds to a start time of a predetermined modification period (MP); if the current frame arrives at the start time of the modification period, receiving an MBMS notification information message for indicating a significant change in the MBMS service, the MBMS notification information message includes an MBMS service identifier (ID), a cause value indicating the cause for the notification, frequency information for the MBMS service, and continue reading information indicating whether to continuously receive control information messages transmitted after the MBMS notification information message; and checking the cause value of the MBMS notification information message, and performing an operation according to the cause value.

According to further another aspect of the present invention, there is provided a method for transmitting control information for supporting a Multimedia Broadcast/Multicast Service (MBMS) service in a mobile communication system providing the MBMS service, the method including the steps of generating an MBMS service list message including control information for at least one MBMS service of a current cell; and transmitting the MBMS service list message to at least one user equipment (UE) located in the current cell, wherein the MBMS service list message includes an MBMS service identifier (ID), information indicating a transfer mode of a corresponding MBMS service, and frequency information for the corresponding MBMS service.

According to further another aspect of the present invention, there is provided a method for receiving control information for supporting a Multimedia Broadcast/Multicast Service (MBMS) service in a mobile communication system providing the MBMS service, the method including the steps of determining if a current frame corresponds to a start time of a predetermined repetition period (RP), if there is a need for receiving an MBMS service list message including control information for at least one MBMS service of a current cell; if the current frame arrives the start time of the repetition period, receiving the MBMS service list message, the MBMS service list message includes an MBMS service identifier (ID), information indicating a transfer mode for a corresponding MBMS service, and frequency information for the corresponding MBMS service; determining if there is an ID of a joined MBMS service in the MBMS service list message; checking a transfer mode of the joined MBMS service, if there is an ID of the joined MBMS service in the MBMS service list message; and receiving the joined MBMS service according to whether the transfer mode of the joined MBMS service corresponds to point-to-multipoint (PtM), point-to-point (PtP), or no-RB (radio bearer).

According to further another aspect of the present invention, there is provided a method for transmitting control information for supporting a Multimedia Broadcast/Multicast Service (MBMS) service in a mobile communication system providing the MBMS service, the method including the steps of generating an MBMS common radio bearer (RB) information message including common control information for RBs, physical channels and transport channels used for MBMS services provided in a current cell; and transmitting the MBMS common RB information message to at least one user equipment (UE) located in the current cell, wherein the MBMS common RB information message includes an RB information list for RBs commonly used by the MBMS services, transport channel information and physical channel information.

According to further another aspect of the present invention, there is provided a method for receiving control information for supporting a Multimedia Broadcast/Multicast Service (MBMS) service in a mobile communication system providing the MBMS service, the method including the steps of receiving an MBMS common radio bearer (RB) information message, if there is a need for receiving the MBMS common RB information message including common control information for RBs, physical channels and transport channels used for MBMS services provided in a current cell, the MBMS common RB information message includes an RB information list for RBs commonly used by the MBMS services, transport channel information and physical channel information; and acquiring the RB information list, the transport channel information and the physical channel information, all of which are included in the MBMS common RB information message.

According to further another aspect of the present invention, there is provided a method for transmitting control information for supporting a Multimedia Broadcast/Multicast Service (MBMS) service in a mobile communication system providing the MBMS service, the method including the steps of generating an MBMS service point-to-multipoint (PtM) radio bearer (RB) information message including control information for MBMS services provided in a current cell and neighbor cells; and transmitting the MBMS service PtM RB information message to at least one user equipment (UE) located in the current cell, wherein the MBMS service PtM RB information message includes current cell RB information including an RB information list for RBs used by MBMS services provided in the current cell, transport channel information and physical channel information, and neighbor cell RB information including an RB information list for RBs used by MBMS services provided in the neighbor cells, transport channel information and physical channel information.

According to further another aspect of the present invention, there is provided a method for receiving control information for supporting a Multimedia Broadcast/Multicast Service (MBMS) service in a mobile communication system providing the MBMS service, the method including the steps of receiving an MBMS notification information message for indicating a significant change in an MBMS service, and receiving an MBMS service point-to-multipoint (PtM) radio bearer (RB) information message including control information for MBMS services provided in a current cell and neighbor cells according to the MBMS notification information message; determining if there is RB information for a joined MBMS service in the MBMS service PtM RB information message; and if there is RB information for the joined MBMS service, acquiring control information for the current cell and the neighbor cells for the joined MBMS service from the MBMS service PtM RB information message.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a network configuration of a 3^{rd} generation asynchronous mobile communication system supporting a Multimedia Broadcast/Multicast Service (MBMS) service;

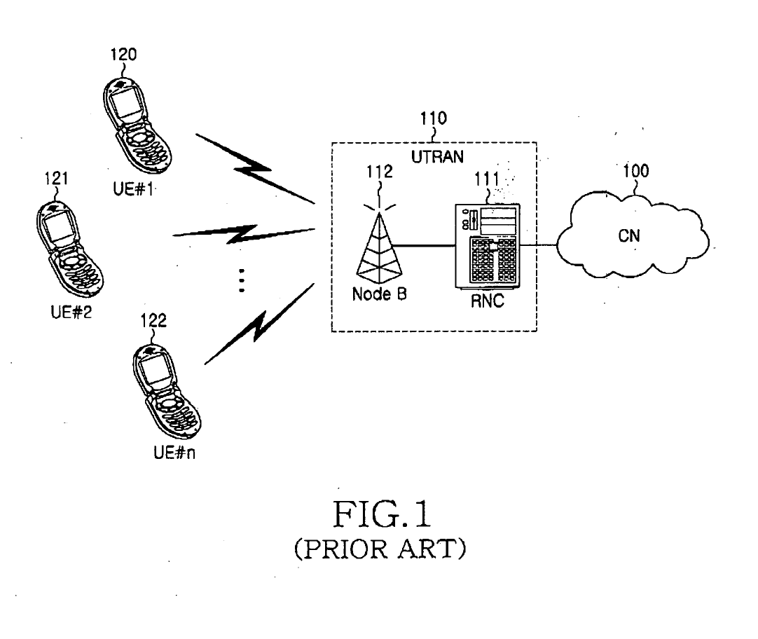

FIG. 2 is a diagram illustrating a protocol structure of a wireless access network in a 3^{rd} generation mobile communication network;

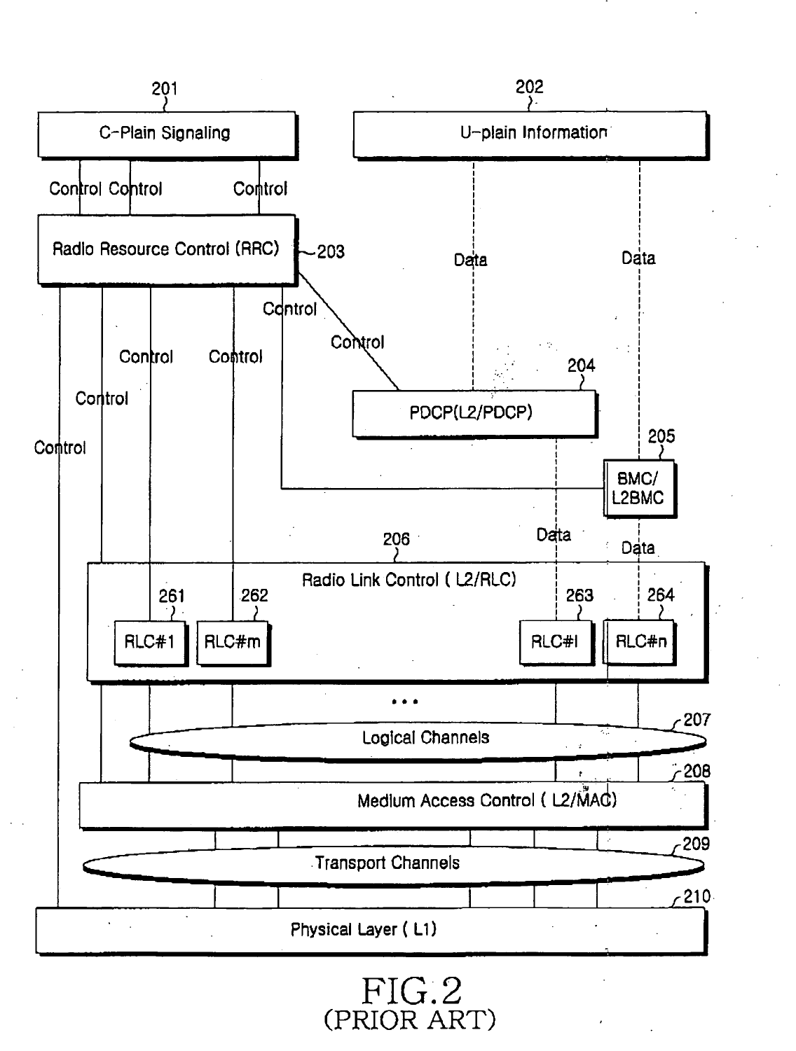

FIG. 3 is a diagram illustrating an example of control information transmitted over an MCCH in a 3 generation mobile communication network;

FIG. 4 is a diagram illustrating an example for transmission and scheduling of control information messages proposed in the present invention;

FIG. 5 is a flowchart illustrating a UTRAN operation of transmitting control information messages proposed in the present invention;

FIG. 6 is a flowchart illustrating a UE operation of receiving an MBMS Notification Info message according to an embodiment of the present invention;

FIG. 7 is a flowchart illustrating a UE operation of receiving an MBMS Service List message proposed in the present invention;

FIG. 8 is a flowchart a UE operation of receiving an MBMS Service PtM RB Info message proposed in the present invention; and

FIG. 9 is a flowchart illustrating a UE operation of receiving an MBMS Common RB Info message proposed in the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

Control information necessary for an MBMS service includes:
1. system information for all of the MBMS services,
2. a transmission start time and a repetition period of the control information transmitted over an MBMS Control Channel (MCCH),
3. channel information (logical channel information, transport channel information and physical channel information) for an MBMS Traffic Channel (MTCH) that transmits MBMS data on a PtM basis,
4. information (e.g., an MBMS service ID) on an MBMS service transmitted over the MTCH,
5. a list of MBMS services of the current cell, provided for mobility of UEs,
6. neighbor cell MBMS information for supporting selective combining (SC) used to increase the MBMS data reception performance of a UE,
7. transmission scheduling information for the MBMS data, for supporting discontinuous transmission (DTX) of the MBMS data transmitted over an MTCH, and
8. information indicating a frequency band in which MBMS service can be received.

Aside from the foregoing information, other control information can be additionally defined. Herein, there are two possible paths through which the control information can be provided to UEs scheduled to receive an MBMS service, and a path used is changed according to a feature of the control information.

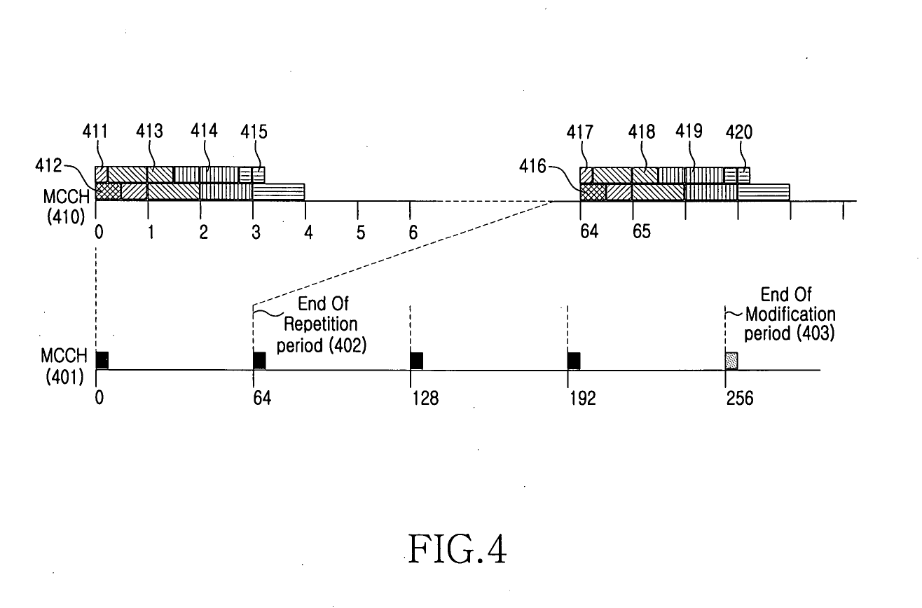

A first method transmits the control information through a BCH, and control information that can be transmitted over the BCH can include system information for all of the MBMS services. The system information can include repetition periods of Notification Indicator Channel (NICH) information indicating the presence of the control information for the transmission and a start of an MBMS service, information on a FACH and an S-CCPCH, over both of which an MCCH is transmitted, and control information transmitted over the MCCH. There are 3 possible repetition periods defined: Modification Period (MP), Repetition Period (RP) and Access Info Period (AIP). A detailed description of the periods will be made later with reference to FIG. 4.

A second method transmits the control information through an MCCH used for the transmission of the control information for an MBMS service. The control information that can be transmitted over the MCCH can include the information described in items 3 to 8 from among the forgoing necessary control information items. That is, a UE receives the control information of items 3 to 8 through an MCCH depending on the control information of items 1 and 2 received over a BCH. In this case, the control information items transmitted over the MCCH overlap each other in several information details. For example, in order to provide information indicating that a particular MBMS service is effective in a cell, it is necessary to transmit an identifier (ID) for the MBMS service. Also, the ID for the MBMS service is required in order to provide information on a channel type for the MBMS service and a channel over which the MBMS service is transmitted.

Embodiments of the present invention described below define the control information messages necessary for an MBMS service, and propose the following control information message formats to prevent the information elements (IEs) of the control information messages from undergoing a duplicate transmission. Control information messages transmitted over an MCCH, proposed in preferred embodiments of the present invention, include:
1. MBMS Notification Info message: This is a control signaling message indicating a start and an end of a session which is a basic transmission unit for an MBMS service. It is used to indicate a significant change in MBMS service, and is also known as an MBMS Modified Service Info message. Also, this can be used for a counting operation to determine the number of UEs in a cell to determine a transfer mode of MBMS data.
2. MBMS Service List message: This is a control signaling message providing a list of MBMS services currently provided in or available in the current cell. It serves to inform a UE powered on in the current cell or UEs entering from another cell of the available MBMS services, and is also known as an MBMS Unmodified Service Info message as it is used for notification on unmodified control information for an MBMS service.
3. MBMS Common RB Info message: This is a control information message used for informing a UE of common information details for radio bearers (RBs), physical channels and transport channels used by MBMS services provided in the current cell, and is also known as an MBMS Common PtM RB Info message. The MBMS Common RB Info message can include RB information for an MBMS service selectively transmitted from neighbor cells. Information on the neighbor cells can be used for selective combining (SC).
4. MBMS Service PtM RB Info message: This is a control information message used for informing a UE of all of the information details for a particular MBMS service which is provided in the current cell on a PtM basis. During new MBMS data transmission, if the MBMS service is performed in neighbor cells, the MBMS Service PtM RB Info message can include neighbor cell information as well. An information part for the current cell is referred to as an MBMS Current Cell PtM RB Info message, and an information part for the neighbor cell is referred to as an MBMS Neighboring Cell PtM RB Info message. A UTRAN preferentially transmits an MBMS Service PtM RB Info message that should be first received, from among several MBMS Service PtM RB Info messages.

Table 3, Table 4, Table 5 and Table 6 below illustrate information elements (IEs) necessary for a description of the present invention for the foregoing control information messages, in which IEs newly defined in the present invention are underlined and expressed in bold. In the following tables, ‘Information Element/Group name’ indicates the names of IEs and the names of groups to which the IEs belong, ‘Need’ indicates whether a corresponding IE is mandatory (MP) or optional (OP), and ‘Multi’ indicates whether the number of IEs is one or several. In addition, ‘Type and reference’ indicates a type in which IEs are expressed, and for example, possible bit expressions include bit-string expression, octet expression, and integer expression. ‘Semantics description’ is a field in which a description is made of the meaning of a corresponding IE, a function of the IE, and which event will happen if the IE is not used. Although many of the possible IEs according to embodiments of the present invention are illustrated herein, particular IEs selected by a system designer can be omitted or unremunerated IEs can be added.

Table 3 illustrates a format of an MBMS Notification Info message and a description of respective IEs.

TABLE 3

| Information | | | | | |
|---|---|---|---|---|---|
| Element/Group | | | Type and | Semantics | |
| name | Need | Multi | reference | description | Comments |
| Message Type | MP | | Message | | Used to indicate MBMS Notification |
| | | | Type | | Info message. |
| XX | | | | | |
| information | | | | | |
| elements | | | | | |
| Service list | OP | maxMBMSservNotif | | Providing | Used in the present of control |
| | | | | details about | information for a particular MBMS |
| | | | | the changed | service, and this IE includes as many |
| | | | | services. May | services as maxMBMSservNotif |
| | | | | be absent in | |
| | | | | case of a | |
| | | | | Common RB | |
| | | | | Info | |
| | | | | modification. | |
| >Service ID | MP | | Bit string | | an ID used to identify an MBMS |
| | | | (32) | | service for which notification is made |
| >CHOICE | MP | | | | IE used to indicate a cause for |
| Notification | | | | | notification |
| cause | | | | | |
| >>Counting | | | | | Indicating that a cause for notification |
| | | | | | is counting for determining the |
| | | | | | number of users for the MBMS data |
| | | | | | transfer mode |
| >>>RACH | OP | | Integer | Absence | Used to control transmission of |
| access | | | (1 . . . 8) | indicates end | uplink RACK for UEs such that |
| probability | | | | of counting | collision between different UEs |
| factor | | | | | should not occur in the process of |
| | | | | | RRC connection for counting in case |
| | | | | | there are four UEs. Absence of this IE |
| | | | | | indicates inactivation of counting. |
| >>PTM RB | | | | Used in case | IE used to indicate that a cause for |
| change | | | | further details | notification is transfer mode of an RB |
| | | | | are provided in | that transmits the MBMS data. |
| | | | | the PTM RB | Transfer mode of the MBMS data |
| | | | | info eg. PTM | includes two modes of PtP and PtM. |
| | | | | RB | |
| | | | | establishment, | |
| | | | | PTM RB re- | |
| | | | | configuration | |
| >>>Short | MP | | Integer | | Identity used to indicate the MBMS |
| MBMS | | | (1 . . . 32) | | service with the transfer mode |
| service | | | | | changed. Because of excessive long |
| identity | | | | | length of IE SERVICE ID, it can |
| | | | | | indicate MBMS service in a cell with |
| | | | | | a length of about 5 bits. |
| >>PTM RB | | | | (no data) | Used to indicate that a cause for |
| release | | | | | notification is to release the RB used |
| | | | | | by the MBMS service due to end of |
| | | | | | data transmission for a particular |
| | | | | | MBMS service. |
| >>Other | | | | (no data) | IE used in case there are additionally |
| | | | | Covering | needed causes except the foregoing |
| | | | | cases like | causes for notification. |
| | | | | frequency | |
| | | | | redirection, | |
| | | | | counting | |
| | | | | decision<PTP, | |
| | | | | no RB> and | |
| | | | | mode change | |
| | | | | to PTP | |
| >Preferred | OP | | 30 b | DL ARFCN | MBMS service can be performed |
| frequency | | | | (14b) and UL | only at a particular frequency in case |
| | | | | ARFCN | several frequencies coexist spatially. |
| | | | | unless default | In this case, this IE is used to indicate |
| | | | | duplex | the frequency at which the MBMS |
| | | | | distance is | service is performed, and UE can |
| | | | | used. It seems | reselect cells having the frequency at |
| | | | | better to | which the MBMS service is |
| | | | | reference a list | performed, using this IE. |
| | | | | on BCCH | |
| >Continue | MP | | BOOLEAN | Indicates that | This IE is used to indicate that the UE |
| MCCH | | | | the UE shall | should continue to receive control |
| reading | | | | continue | information transmitted after the |
| | | | | reading | Notification Info message. Control |
| | | | | MCCH in the | information messages that the UE |
| | | | | next | should receive after Notification Info |
| | | | | modification | message include MBMS SERVICE |
| | | | | period (since | PTM RB INFO, or MBMS |
| | | | | more changes | COMMON RB INFO. |
| | | | | are | |
| | | | | forthcoming) | |
| Common RB | OP | | | Included in | IE used in case there is a change in |
| value tag | | | | case of | contents of COMMON RB INFO. In |
| | | | | common RB | the case there is a change in contents |
| | | | | info | of COMMON RB INFO, release of |
| | | | | modification | PTM RB or reconfiguration of |
| | | | | and if the | existing RBs are available. The UE |
| | | | | notification | compares this IE with a value tag of |
| | | | | includes a | MBMS COMMON RB INFO |
| | | | | PTM RB | received before this message, and if |
| | | | | establishment | the two values are different, receives |
| | | | | or re- | MBMS COMMON RB INFO to |
| | | | | configuration | acquire new information. |
| | | | | for one or | |
| | | | | more services | |
| Scheduling | OP | | Integer | Indicates the | When receiving control messages |
| info | | | (1 . . . 256) | final TTI | transmitted over the MCCH, the UE |
| | | | | containing | can determine the transmission start |
| | | | | MBMS | time of each message through the MP, |
| | | | | SERVICE | RP and AIP on the BCH, but cannot |
| | | | | INFO for | determine an end time of each |
| | | | | changed | message, because a length of each |
| | | | | services or the | message is variable. This IE allows |
| | | | | final TTI | the UE to exactly determine an end of |
| | | | | containing the | each message, preventing the UE |
| | | | | changed | from unnecessarily receiving the |
| | | | | MBMS | MCCH, thereby saving reception |
| | | | | COMMON | power of the UE. |
| | | | | RB INFO | |
| | | | | included in | |
| | | | | case of PTM | |
| | | | | RB | |
| | | | | establishment | |
| | | | | & re- | |
| | | | | configuration | |
| | | | | and/or change | |
| | | | | of common | |
| | | | | RB | |
| | | | | configuration | |

Table 4 illustrates a format of an MBMS Service List message.

TABLE 4

| Information | | | | | |
|---|---|---|---|---|---|
| Element/Group | | | Type and | Semantics | |
| name | Need | Multi | reference | description | Comments |
| Message Type | MP | | Message | | This IE is used to indicate an MBMS |
| | | | Type | | SERVICE LIST message. |
| XX information | | | | | |
| elements | | | | | |
| Service list | MP | maxMBMSservCell | | | This IE can include as many services as |
| | | | | | maxMBMSservCell indicating the |
| | | | | | number of the MBMS services |
| | | | | | provided in the current cell. |
| >Service ID | MP | | Bit string | | This IE is an ID for an MBMS service |
| | | | (32) | | provided in the current cell. |
| >CHOICE | MP | | | | IE used to indicate transfer mode of the |
| Transfer mode | | | | | MBMS service indicated by the IE |
| | | | | | SERVICE ID |
| >>PTM | | | | | IE indicating that the MBMS service |
| | | | | | indicated by the IE SERVICE ID is |
| | | | | | transmitted in PtM mode. |
| >>>Short | MP | | Integer | | IE indicating short identity used by the |
| MBMS service | | | (1 . . . 32) | | MBMS service indicated by the IE |
| identity | | | | | SERVICE ID. The short identity is |
| | | | | | used for identifying the MBMS service |
| | | | | | in another message through which |
| | | | | | control information for the MBMS |
| | | | | | service is transmitted. |
| >>PTP | | | | (no data) | IE indicating that the MBMS service |
| | | | | | indicated by the IE SERVICE ID is |
| | | | | | transmitted in Ptp mode. |
| >>No RB | | | | (no data) | IE indicating that the MBMS service |
| | | | | | indicated by the IE SERVICE ID can |
| | | | | | be provided but is not currently |
| | | | | | transmitted. |
| >Preferred | OP | | 30b | DL ARFCN | IE used to indicate a frequency at |
| frequency | | | | (14b) and | which the MBMS service is transmitted |
| | | | | UL ARFCN | |
| | | | | unless | |
| | | | | default | |
| | | | | duplex | |
| | | | | distance is | |
| | | | | used. It | |
| | | | | seems better | |
| | | | | to reference | |
| | | | | a list on the | |
| | | | | BCCH. | |
| >Continue | MP | | BOOLEAN | Indicates that | This IE is used to indicate that the UE |
| MCCH | | | | the UE shall | should continue to receive control |
| reading | | | | continue | information transmitted after the |
| | | | | reading the | MBMS Service List message. Control |
| | | | | MCCH in | information messages that UE should |
| | | | | the next | continuously receive after the MBMS |
| | | | | modification | Service List message include MBMS |
| | | | | period (since | SERVICE PTM RB INFO or MBMS |
| | | | | changes are | COMMON RB INFO. |
| | | | | forthcoming) | |
| Common RB | MP | | | Included | This IE is used in case there is a change |
| value tag | | | | even if none | in contents of COMMON RB INFO. In |
| | | | | of the | the case where there is a change in |
| | | | | services is | contents of COMMON RB INFO, |
| | | | | provided via | release of the PTM RB or the |
| | | | | the PTM RB | reconfiguration of existing the RBs are |
| | | | | | available. UE compares this IE with a |
| | | | | | value tag of MBMS COMMON RB |
| | | | | | INFO received before this message, |
| | | | | | and if the two values are different, |
| | | | | | receives MBMS COMMON RB INFO |
| | | | | | to acquire new information. |

Table 5 illustrates a format of an MBMS Common RB Info message.

TABLE 5

| Information | | | | | |
|---|---|---|---|---|---|
| Element/Group | | | Type and | Semantics | |
| name | Need | Multi | reference | description | Comments |
| Message Type | MP | | Message | | This IE is used to indicate the MBMS |
| | | | Type | | Common RB Info message. |
| RB | | | | | Group name indicating the IEs related |
| information | | | | | to the RB |
| elements | | | | | |
| Common RB | MP | | | Valid within | This IE is used to indicate a change in |
| info value tag | | | | the scope of a | the IEs currently included in the |
| | | | | cell group | COMMON RB INFO message. In the |
| | | | | | case there is a change in the IEs |
| | | | | | contained in the COMMON RB |
| | | | | | INFO message, a value of this IE is |
| | | | | | different from a value tag common |
| | | | | | RB info value in the COMMON RB |
| | | | | | INFO message transmitted before this |
| | | | | | message. When the SC used to |
| | | | | | increase the throughput of the MBMS |
| | | | | | data is introduced, the same MBMS |
| | | | | | service can be serviced with the same |
| | | | | | RB in neighbor cells. Thus, this IE |
| | | | | | can also be used to indicate a change |
| | | | | | in MBMS RB Info of the neighbor |
| | | | | | cells in the case where the MBMS RB |
| | | | | | change information of neighbor cells |
| | | | | | is transmitted within Common RB |
| | | | | | Info. |
| PTM RB info | MP | maxMBMS- | | | This IE indicates a list of the RBs that |
| list | | RB | | | transmit the MBMS data in the PTM |
| | | | | | mode, and can include as many RBs |
| | | | | | as maxMBMS-RB. |
| >RB identity | MP | | Integer | Beneficial to | This IE is an identity indicating the |
| | | | (1 . . . 32) | the facilitate | RB that transmits the PtM MBMS |
| | | | | removal of the | data. |
| | | | | configurations | |
| >PDCP info | MP | | | | Packet Data Convergence Protocol |
| | | | | | (PDCP) is a part of L2, which |
| | | | | | compress a part unnecessary for the |
| | | | | | transmission of the packet data before |
| | | | | | the transmission, and this IE indicates |
| | | | | | the information used in the PDCP. |
| >RLC info | MP | | | | Radio Link Control (RLC) is a part of |
| | | | | | the L2, used to transmit/receive the |
| | | | | | data in the retransmission mode or the |
| | | | | | ordered mode, and this IE indicates |
| | | | | | information used in the RLC. |
| PhyCh and | | | | | Group name indicating the IEs used |
| TrCh | | | | | for the physical channels and the |
| information | | | | | transport channels |
| elements | | | | | |
| SCCPCH list | MP | MaxMBMS- | | S-CCPCH on | IE capable of indicating a list of S- |
| | | SCCPCH | | to which both | CCPCHs on which the MCCH or the |
| | | | | MCCH and | MTCH is transmitted. This IE can |
| | | | | MTCH are | have as many S-CCPCHs as |
| | | | | mapped are | maxMBMS-SCCPCH. |
| | | | | specified on | |
| | | | | BCCH | |
| >S-CCPCH | MP | | Integer | Beneficial to | Identity capable of indicating S- |
| identity | | | (1 . . . 16) | facilitate | CCPCH over which the MCCH or the |
| | | | | removal of | MTCH is transmitted |
| | | | | configuration | |
| >TFCS | MP | | | | This IE indicates a transport format of |
| | | | | | the transport channels which are |
| | | | | | mapped to the S-CCPCH before |
| | | | | | being transmitted. Transport Format |
| | | | | | Combination Set (TFCS) indicates a |
| | | | | | transport format combination for the |
| | | | | | FACHs mapped to the S-CCPCH |
| | | | | | corresponding to the S-CCPCH |
| | | | | | identity IE. |
| >FACH list | MP | maxFACHPCH | | | IE capable of indicating a list of the |
| | | | | | FACHs mapped to the S-CCPCH |
| | | | | | corresponding to the S-CCPCH |
| | | | | | identity IE. This IE can have as many |
| | | | | | FACHs as maxFACHPCH. |
| >>FACH | MP | | Integer | Beneficial to | This IE indicates the identity capable |
| identity | | | (1 . . . 16) | facilitate | of the identifying FACHs mapped to |
| | | | | removal of | the S-CCPCH corresponding to the S- |
| | | | | configurations | CCPCH identity IE. |
| >>TFS | MP | | | | This IE indicates Transmit Format Set |
| | | | | | of FACHs mapped to S-CCPCH |
| | | | | | corresponding to the S-CCPCH |
| | | | | | identity IE. |
| >Secondary | MP | | | | Physical channel information of S- |
| CCPCH info | | | | | CCPCH corresponding to the S- |
| | | | | | CCPCH identity IE |

Table 6 illustrates a format of an MBMS Service PtM RB Info message.

TABLE 6

| Information | | | | | |
|---|---|---|---|---|---|
| Element/Group | | | Type and | Semantics | |
| name | Need | Multi | reference | description | Comments |
| Message Type | MP | | Message | | This IE is used to indicate the MBMS |
| | | | Type | | Service PTM RB Info message. |
| XX | | | | | |
| information | | | | | |
| elements | | | | | |
| Short MBMS | MP | | Integer | | This IE serves to indicate the |
| service | | | (1 . . . 32) | | information on PtM RB through |
| identity | | | | | which the MBMS service having the |
| | | | | | MBMS service ID corresponding to a |
| | | | | | short MBMS service identity IE |
| | | | | | acquired from the Notification Info is |
| | | | | | transmitted. |
| Current cell | MP | | | The exiting | This IE indicates information on the |
| RAB | | | | model is re- | Radio Access Bearer (RAB) used in |
| information | | | | used in which | the current cell by an MBMS service |
| | | | | one service | corresponding to the short MBMS |
| | | | | maps to a | service identity IE. The RAB refers to |
| | | | | RAB which | a connection path between UE and |
| | | | | may map to | CN, and is different from the RB in |
| | | | | one or more | that the RB is a connection path |
| | | | | RBs. See note 1 | between the UE and the UTRAN. |
| >RB | MP | maxRBperRAB | | | Several of the RBs can be used for |
| information | | | | | one RAB, and this IE is used to |
| list | | | | | indicate a list of several of the RBs |
| | | | | | used for one RAB and can have as |
| | | | | | many RBs as maxRBperRAB. |
| >>RB identity | MP | | Integer | Identifies a RB | This IE can be used to indicate the |
| | | | (1 . . . 32) | configuration | RB identity. |
| | | | | included in the | |
| | | | | MBMS | |
| | | | | COMMON | |
| | | | | RB INFO | |
| | | | | message | |
| >>RB | MP | | | Note 2 | This IE is used to indicate the |
| mapping info | | | | | transport channels and the physical |
| | | | | | channels mapped to RB. |
| >>>Logical | OP | | Integer | Used to | This IE is used to indicate identities |
| channel | | | (1 . . . 16) | distinguish | for distinguishing MTCHs, being |
| identity | | | | different | logical channels, mapped to the RB. |
| | | | | MTCH within | The MTCHs have unique identities |
| | | | | the MAC | within one FACH. |
| | | | | header. | |
| | | | | Identifier is | |
| | | | | unique within | |
| | | | | the scope of | |
| | | | | the indicated | |
| | | | | FACH. | |
| >>>CHOICE | MP | | | | This IE indicates whether the MBMS |
| Specification | | | | | service indicated by the MBMS |
| mod | | | | | Service PTM RB Info message can |
| | | | | | use RB Info used before this message. |
| >>>>Same as | | | | | This IE indicates that MBMS service |
| previous | | | | | indicated by the MBMS Service PTM |
| | | | | | RB Info message can use the same |
| | | | | | RB information as the previous RB of |
| | | | | | the RB corresponding to the RB |
| | | | | | identity IE. |
| >>>>Different | | | | | This IE indicates the new RB |
| | | | | | mapping info to be used by the |
| | | | | | MBMS service indicated by the |
| | | | | | MBMS Service PTM RB Info |
| | | | | | message. |
| >>>>>FACH | OP | | Integer | Identifier is | This IE is used to indicate the IDs for |
| identity | | | (1 . . . 16) | unique within | the FACHs in the S-CCPCH to which |
| | | | | the scope of | the FACHs corresponding to this IE is |
| | | | | the indicated | mapped. This IE is unnecessary when |
| | | | | S-CCPCH. | only one FACH is used. |
| | | | | Absent if a | |
| | | | | single FACH | |
| | | | | is mapped on | |
| | | | | to the | |
| | | | | indicated S- | |
| | | | | CCPCH. | |
| >>>>>S- | MP | | Integer | Identifies a | This IE indicates the S-CCPCH |
| CCPCH | | | (1 . . . 16) | PhyCh and | defined in the Common RB Info |
| identity | | | | TrCh | message. The meaning of this IE |
| | | | | configuration | indicates that the information on S- |
| | | | | included in the | CCPCH of Common RB Info |
| | | | | MBMS | message should be used. |
| | | | | COMMON | |
| | | | | RB INFO | |
| | | | | message. The | |
| | | | | assumption is | |
| | | | | that UE is | |
| | | | | required to | |
| | | | | receive all of | |
| | | | | the FACHs | |
| | | | | (according to | |
| | | | | its capabilities | |
| | | | | on the S- | |
| | | | | CCPCH) | |
| Neighboring | OP | MaxMBMSneighCell | | Allowing for | This IE serves to allow the UE to |
| cell RAB | | | | up to 32 | perform the SC by informing the UE |
| information | | | | neighboring | of information on neighbor cells for |
| | | | | cells. Absent if | MBMS service the UE is receiving. |
| | | | | selection | This IE can inform the UE of |
| | | | | combining is | information on a maximum of |
| | | | | not used for | maxMBMSneighCell of neighbor |
| | | | | this service. | cells. |
| >Cell identity | MP | | Integer | Corresponds | This IE serves to indicate the MBMS |
| | | | (0 . . . <max | with the inter- | data of neighbor cells that UE will |
| | | | CellMeas | frequency cell | use for the SC using identities of |
| | | | >−1) | id as specified | neighbor cells, transmitted through |
| | | | | within SIB | the BCH. |
| | | | | 11/12 | |
| >RB | OP | maxRBperRAB | | Absent for the | This IE serves to indicate the RB |
| information | | | | first entity if | information of the neighbor cells for |
| list | | | | the | the MBMS service that UE is |
| | | | | configuration | currently receiving. Absence of this |
| | | | | is exactly the | IE indicates that the UE can receive |
| | | | | same as in the | signals from a neighbor cell, |
| | | | | current cell, | corresponds to the Cell identity IE |
| | | | | Absent for | using RB information used in the |
| | | | | subsequent | current cell. In the absence of this IE |
| | | | | cells if the | in information on neighbor cell |
| | | | | configuration | having a cell identity different from |
| | | | | is exactly the | the cell identity IE, it indicates that |
| | | | | same as that | the same RB information as that of |
| | | | | for the | the other cell is used. This IE can |
| | | | | previous cell. | have as many RBs as |
| | | | | | maxRBperRAB. |
| >>Logical | OP | | Integer | Used to | This IE is the identity for |
| channel | | | (1 . . . 32) | distinguish the | distinguishing MTCHs in the S- |
| identity | | | | different | CCPCH. |
| | | | | MTCH within | |
| | | | | the MAC | |
| | | | | header. | |
| | | | | Identifier is | |
| | | | | globally | |
| | | | | unique within | |
| | | | | the scope of | |
| | | | | the S-CCPCH | |
| | | | | carrying the | |
| | | | | MTCH | |
| >>CHOICE | MP | | | RB identity is | This IE is used for indicating the RB |
| Neighbor RB | | | | not included | mapping info of neighbor cells. |
| mapping. | | | | since PDCP | |
| mode | | | | and RLC | |
| | | | | configurations | |
| | | | | are the same | |
| | | | | when using | |
| | | | | selection | |
| | | | | combining | |
| >>>Same as | | | | | This IE serves to indicate that the RB |
| previous | | | | | mapping info of initially defined |
| | | | | | neighbor cell or the RB mapping info |
| | | | | | of previously defined neighbor cell is |
| | | | | | used as that of neighbor cell |
| | | | | | corresponding to the Cell identity IE. |
| >>>Different | | | | | This IE is used to indicate the RB |
| | | | | | mapping info corresponding to the |
| | | | | | Cell identity IE. |
| >>>>FACG | OP | | Integer | Identifier is | This IE is used to indicate the |
| identity | | | (1 . . . 16) | unique within | identities for the FACHs in the S- |
| | | | | the scope of | CCPCH to which the FACHs |
| | | | | the indicated | corresponding to this IE are mapped. |
| | | | | S-CCPCH. | This IE is unnecessary when only one |
| | | | | Absent if a | FACH is used. |
| | | | | single FACH | |
| | | | | is mapped on | |
| | | | | to the | |
| | | | | indicated S- | |
| | | | | CCPCH. | |
| >>>>S- | MP | | Integer | Identifies a | This IE indicates the S-CCPCH |
| CCPCH | | | (1 . . . 16) | PhyCh and | defined in the Common RB Info |
| identity | | | | TrCh | message. A meaning of this IE |
| | | | | configuration | indicates that the S-CCPCH |
| | | | | included in the | information in the Common RB Info |
| | | | | MBMS | message should be used. S-CCPCH |
| | | | | COMMON | defined in SIB 5 or 6 for current cell |
| | | | | RB INFO | can be used. |
| | | | | message or in | |
| | | | | SYSTEM | |
| | | | | INFORMATION | |
| | | | | BLOCK | |
| | | | | TYPE 5 or 6 | |

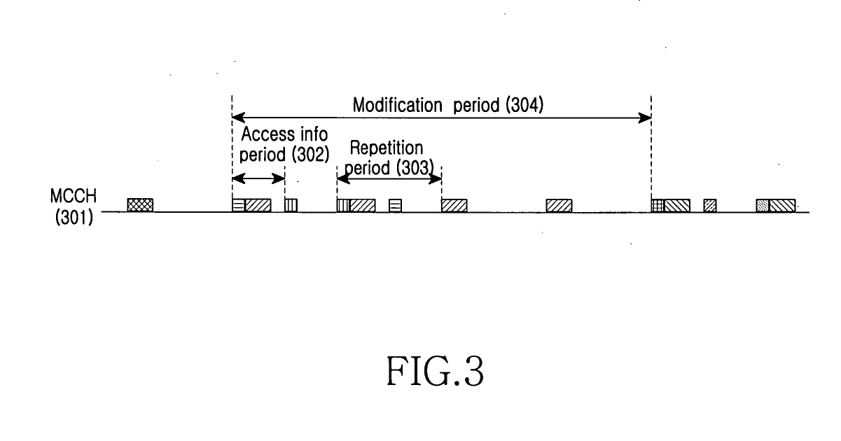

FIG. 3 is a diagram illustrating a transmission start time and a transmission period for the control information transmitted over an MCCH, and FIG. 4 is a diagram illustrating the transmission and scheduling for the messages presented in Table 3, Table 4, Table 5 and Table 6.

Referring first to FIG. 3, an MCCH 301 transmits various control information messages for supporting an MBMS service. The control information messages include information transmitted to inform UEs of a start/end of the MBMS service and a significant change in the MBMS service, and can also include control information periodically repeated to guarantee the continuity of the MBMS service by taking into consideration the movement of the UE in the mobile communication system. A Modification Period (MP) 304 indicates a period for which the contents of the periodically repeated control information remain unmodified. That is, for the MP 304, the contents of the control information are unmodified. A Repetition Period (RP) 303 represents a period for which the same control information is repeatedly transmitted. The MP 304 can include several RPs 303. An Access Information Period (AIP) 302 is a period used when a counting operation for determining a transfer mode of an MBMS service is performed, and for each AIP 302, a RACH acquisition probability at which the counting operation is to be performed is changed. The RACH acquisition probability is a value used to prevent many UEs from attempting a RACH acquisition at one time, causing a collision. The RACH acquisition probability can be transmitted through the MBMS Notification Info message described above, and if the same MBMS Notification Info message is repeated for several RPs 303, the AIP 302 becomes equal to the RP 303 in length.

FIG. 4 is a diagram illustrating an example in which messages transmitted through an MCCH proposed in the present invention are transmitted according to an RP and an MP described with reference to FIG. 3. Referring to FIG. 4, it is assumed that an MP, as represented by reference numeral 403, has a length of 256, and an RP, as represented by reference numeral 402, has a length of 64. The 256 means a length of 256 10-ms radio frames which are used as a basic unit for radio communication transmission in 3GPP, and the 64 means a length of 64 10-ms radio frames. In the 3GPP system, a system frame number (SFN) is used to distinguish a time by 10 ms, and the SFN can have a value of 0 to 4091.

Reference numeral 410 represents an enlarged period of an MCCH denoted by reference numeral 401. Reference numeral 412 indicates an MBMS Notification Info message and the MBMS Notification Info message is transmitted at a start time of the MP. Reference numeral 411 indicates an MBMS Service PtM RB Info message for a particular MBMS service, and when the MBMS Service PtM RB Info message is transmitted at a start time of the MP or transmitted immediately after the MBMS Notification Info message 412 or when a transfer rate of an MCCH is high, the MBMS Service PtM RB Info message 411 can be transmitted together with the MBMS Notification Info message 412. Reference numeral 413 indicates an MBMS Service List message, and the MBMS Service List message 413 has a list of all of the MBMS services currently provided in or available in the current cell, guaranteeing the continuity of an MBMS service by taking the movement of a UE into consideration. A UE receiving or attempting to receive an MBMS service, receives a Common RB value tag through the MBMS Notification Info message 412 and the MBMS Service List message 413, and if the received Common RB value tag is different from a Common RB value tag currently stored in the UE, the UE receives an MBMS Common RB Info message 415. Reference numeral 414 indicates an MBMS Service PtM RB Info message having PtM RB information for another MBMS service.

In FIG. 4, reference numerals 416, 417, 418, 419 and 420 represent the same control information messages denoted by reference numerals 411, 412, 413, 414 and 415, respectively, and as illustrated, the control information messages are repeated every RP 402. The control information messages can be transmitted at a selected time if the transfer rate of the MCCH is very high, and can be transmitted on a time-division basis if the transfer rate of the MCCH is low.

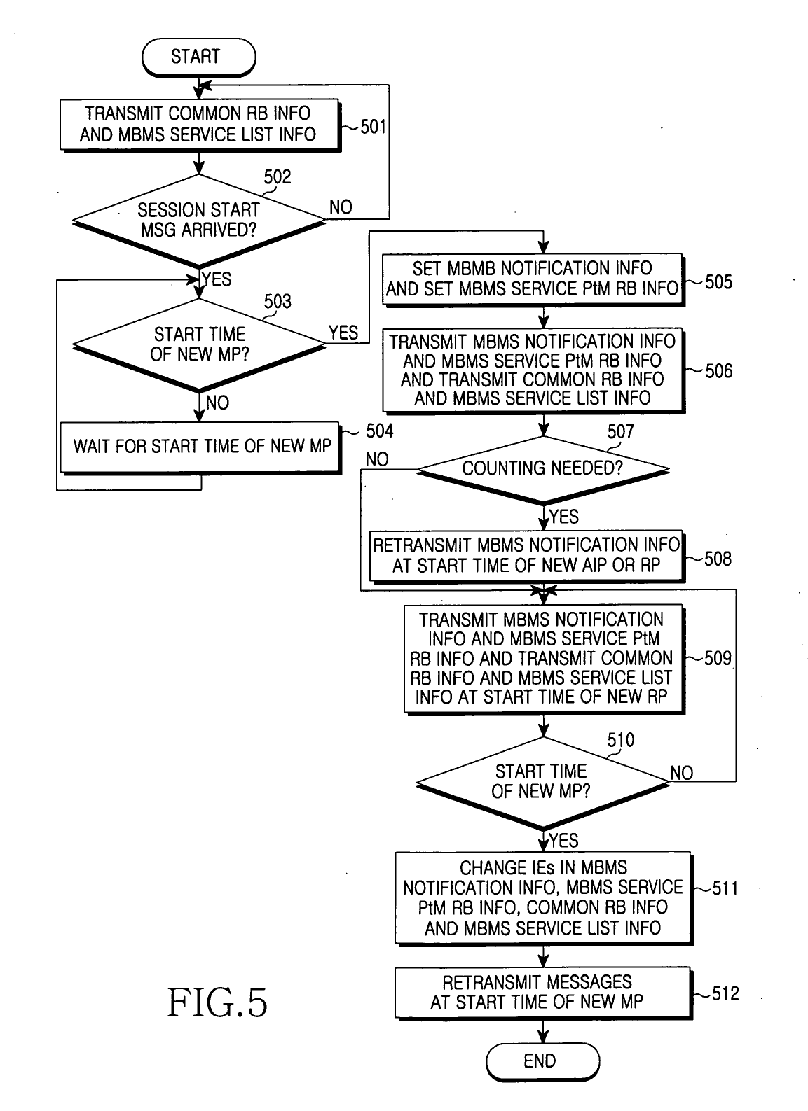

FIG. 5 is a flowchart illustrating an operation of a UTRAN (particularly, an RNC) according to an embodiment of the present invention. Specifically, FIG. 5 is a flowchart illustrating an operation of transmitting control information messages for an MCCH proposed in the present invention upon receiving from a CN a Session Start message indicating a start of data transmission for a particular MBMS service.

Referring to FIG. 5, in step 501, a UTRAN transmits an MBMS Common RB Info message and an MBMS Service List message in order to support UE mobility. If the UTRAN receives a Session Start message for an MBMS service from a CN in step 502, it proceeds to step 503. However, if the UTRAN receives no Session Start message for an MBMS service from the CN, the UTRAN does not return the step 501. In step 503, the UTRAN determines if a current frame corresponds to a start time of a new MP. If the current frame does not correspond to the start time of the new MP, the UTRAN waits until the start time of the new MP in step 504. If the UTRAN recognizes the approach of the start time of the new MP in step 503, it sets up an MBMS Notification Info message and an MBMS Service PtM RB Info message based on a Session Start message received for the MBMS service in step 505. The contents of the MBMS Notification Info message and the MBMS Service PtM RB Info message are illustrated in Table 3 and Table 6 proposed in the present invention. Although step 505 can precede step 503, step 505 is shown to follow step 503.

Upon arrival at the start time of the new MP, the UTRAN transmits in step 506 the MBMS Notification Info message, the MBMS Service PtM RB Info message, an MBMS Common RB Info message, and an MBMS Service List message. The MBMS Service List message and the MBMS Common RB Info message are illustrated in Table 4 and Table 5. The MBMS Common RB Info message does not include changes related to a new MBMS service indicated by the MBMS Notification Info message at the current transmission time, but corresponding changes can be transmitted at the time when the MBMS service is performed. The MBMS Service List message can indicate if an MBMS service indicated by the MBMS Notification Info message will be provided in the current cell. In step 507, the UTRAN determines if a counting operation is needed to determine a transfer mode of MBMS data, and if the counting operation is not required, the UTRAN proceeds to step 509. However, if the counting operation is needed, the UTRAN proceeds to step 508. The UTRAN retransmits the MBMS Notification Info message at a start time of a new AIP or RP in step 508, and then proceeds to step 509. In the MBMS Notification Info message, a different RACH access probability value from the value transmitted in step 506 is set.

In step 509, the UTRAN retransmits the MBMS Notification Info message, the MBMS Service PtM RB Info message, the MBMS Common RB Info message, and the MBMS Service List message at a start time of a new RP. In step 510, the UTRAN determines whether it is time to start a new MP. If it is time to start a new MP, the UTRAN proceeds to step 511, and if it is not time to start the new MP, the UTRAN returns to step 509.

In step 511, the UTRAN modifies IEs to be modified, if any, included in the MBMS Notification Info message, the MBMS Service PtM Info message, the MBMS Common RB Info message, and the MBMS Service List message. If the contents of the MBMS Common RB Info message are modified, the UTRAN modifies a corresponding Common RB value tag. An effective range of the Common RB value tag can be limited to the inside of a cell, or can be defined as several cells that transmit the same MBMS service. In the case where the effective range is limited to the inside of a cell, the Common RB value tag is modified only when MBMS-related RB information in the cell is modified. If the effective range is defined as several cells, the Common RB value tag can be modified when MBMS-related RB information of neighbor cells is modified. In step 512, the UTRAN retransmits the control information messages at a start time of a new MP.

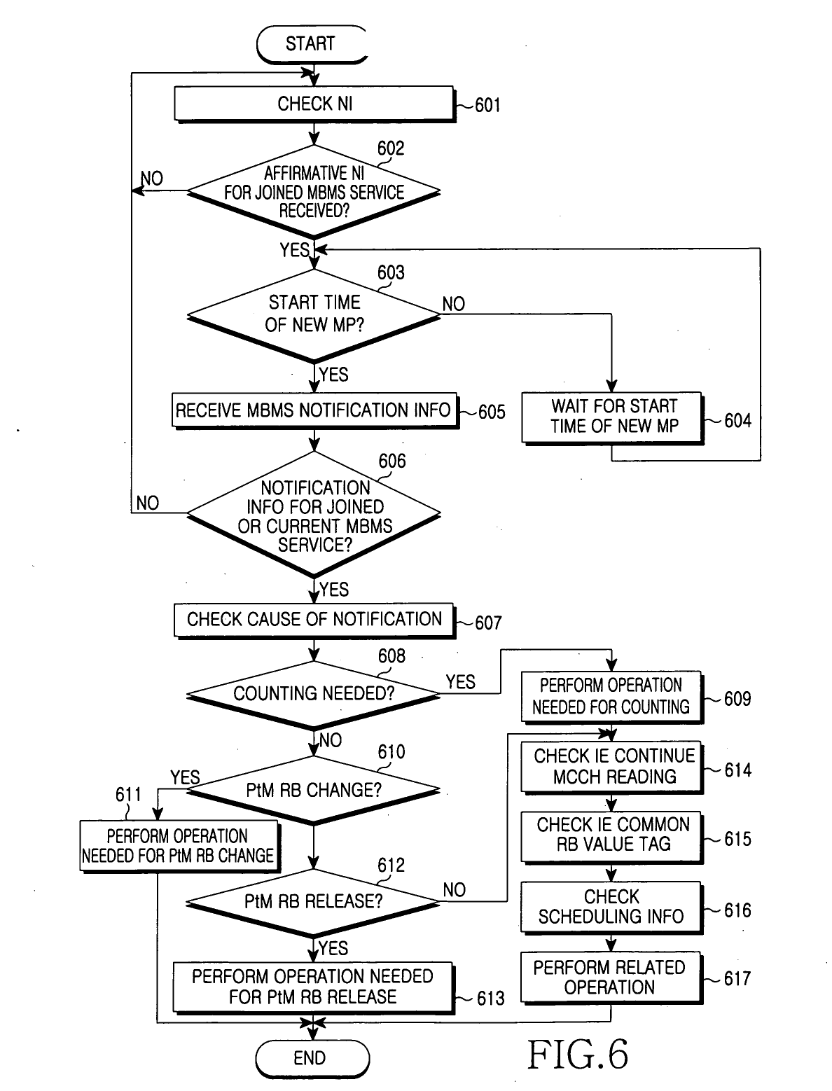

FIGS. 6 to 9 are flowcharts illustrating operations of a UE upon receiving 4 control information messages transmitted over an MCCH, proposed in the present invention.

FIG. 6 is a flowchart illustrating an operation of receiving an MBMS Notification Info message by a UE according to an embodiment of the present invention. Referring to FIG. 6, in step 601, the UE checks a Notification Indicator (NI) indicating expected transmission of an MBMS Notification Info message through an MBMS notification Indication Channel (MICH). In step 602, the UE determines if the NI is an affirmative NI indicating an expected transmission of an MBMS Notification Info message for an MBMS service joined by the UE itself. If the NI is an affirmative NI, the UE proceeds to step 603, and if the NI is a negative NI, the UE returns to step 601.

In step 603, the UE determines if the current frame is a start time of a new MP. The start time of the new MP can be can be determined through a BCH over which the MBMS system information can be transmitted. If it is determined in step 603 that the UE detects a start time of the new MP, the UE proceeds to step 605, and otherwise, proceeds to step 604 where it waits for a start time of a new MP. In step 605, the UE receives an MBMS Notification Info message through an MCCH, and determines in step 606 if the received MBMS Notification Info message is for an MBMS service joined by the UE or currently in service. During the “joining” process a UE informs the RNC/SGSN of an interest in a service, and the RNC/SGSN stores an ID of the UE and location information of the UE. When the service of interest starts, the UE begins to receive the service and is referred to as being currently in service.

The UE performs step 606 using an IE MBMS service ID included in the MBMS Notification Info message. If the received MBMS Notification Info message is not for an MBMS service joined by the UE or currently in service, the UE returns to step 601, and otherwise, proceeds to step 607 where it checks a cause value included in the MBMS Notification Info message. In FIG. 6, although operations on 3 cause values illustrated in Table 3, i.e. Counting, PtM RB change, and PtM RB release will be described, the UE performs the operations according to other cause values, if they are set. If the UE recognizes in step 608 that counting is performed, it performs a counting-related operation in step 609 and then proceeds to step 614. The UE can immediately perform step 614 regardless of completion of the counting.

However, if the UE determines in step 608 that counting is not performed, it recognizes in step 610 that PtM RB change is performed, and performs a PtM RB change-related operation in step 611. If the UE recognizes in step 610 that the PtM RB change is not performed, it recognizes in step 612 that PtM RB release is performed, and then performs an operation necessary for the PtM RB release in step 613.

Herein, the “counting-related operation” refers to an operation of attempting an RRC connection or a PtM connection for counting. The “PtM RB change” means that PtM RB information for an MBMS service that the UE was receiving has been changed, and the UE performs an RB change operation by receiving Common RB Info or MBMS service PtM RB Info. The “PtM RB release operation” refers to an operation of releasing current RB information because it is not necessary to maintain the current RB due to an end of a session for the MBMS service that the UE was receiving.

If none of the causes of steps 608, 610 and 612 is recognized, a session for an MBMS service joined by the UE starts without the counting operation. Therefore, the UE checks the IEs required for the MBMS Notification Info message in at least one of steps 614 to 616.

In step 614, the UE checks an IE continue MCCH reading, and based on the check result, determines if it should receive control information messages transmitted over an MCCH successively after the MBMS Notification Info message. In step 615, the UE checks an IE Common RB value tag to determine if it should receive again a Common RB Info. In step 616, the UE checks IE Scheduling Info to determine an end time of an MBMS Service PtM RB Info message or an MBMS Common RB Info message. With the use of the IE Scheduling Info, the UE can correctly presume an end time of MBMS Service PtM RB Info message and the MBMS Common RB Info message without the necessity of continuously monitoring an MCCH. After checking all of the IEs of the MBMS Notification Info message, the UE performs a required operation in step 617. Herein, the “required operation” refers to an operation of receiving succeeding control information messages or storing required information.

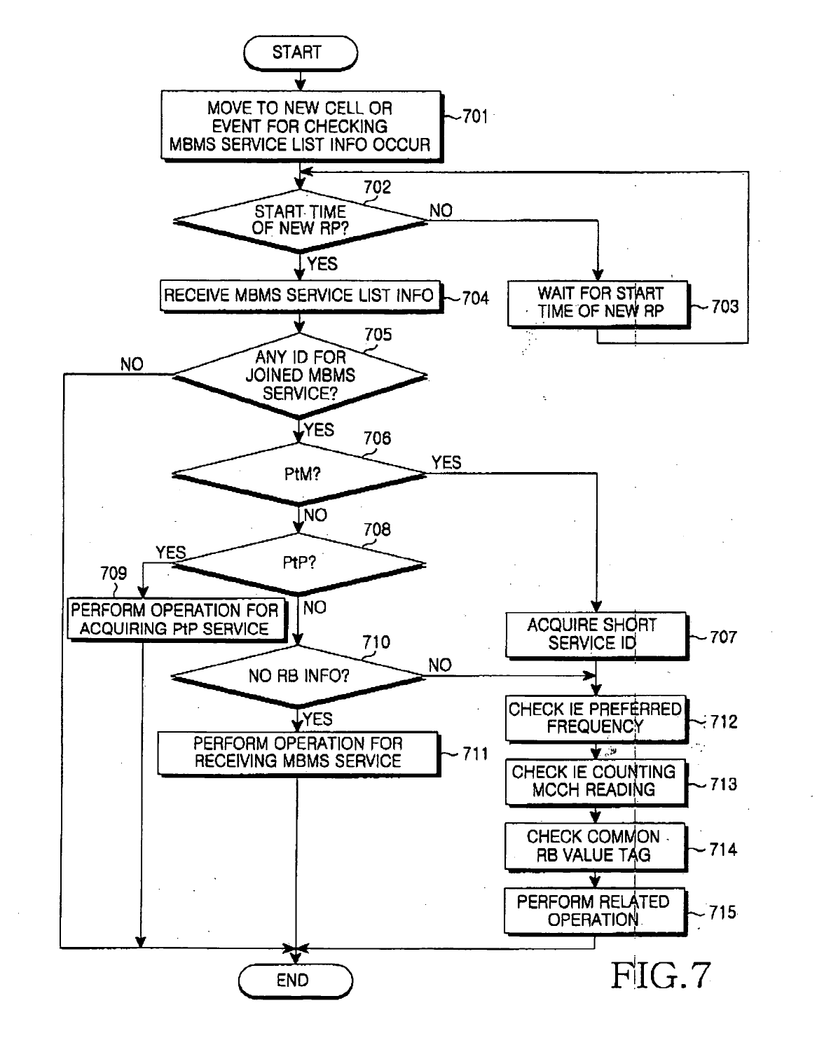

FIG. 7 is a flowchart illustrating an operation of receiving an MBMS Service List message by a UE according to a preferred embodiment of the present invention. Referring to FIG. 7, if a UE moves to a new cell or there is an event to receive an MBMS Service List message in step 701, the UE determines in step 702 if a current frame corresponds to a start time of a new RP. If the current frame corresponds to the start time of the new RP, the UE receives an MBMS Service List message through an MCCH in step 704, and otherwise, waits for a start time of a new RP in step 703.

In step 705, the UE determines if there is an ID for an MBMS service joined by the UE in the received MBMS Service List message, and ends the operation if there is no ID for the joined MBMS service. However, if there is an ID for the MBMS service joined by the UE in step 705, the UE determines in step 706 if a transfer mode for an MBMS service corresponding to the MBMS service ID corresponds to PtM depending on an IE Transfer mode included in the MBMS Service List message. If the transfer mode is PtM, the UE proceeds to step 707, and otherwise, proceeds to step 708. In step 707, the UE acquires an MBMS Short service ID, i.e. an MBMS Transmission Identity, corresponding to the ID of the MBMS service joined by the UE, and then proceeds to step 712. In step 708, the UE determines if the transfer mode of the MBMS service joined by the UE corresponds to PtP based on the IE Transfer mode. If the transfer mode corresponds to PtP, the UE proceeds to step 709, and otherwise, proceeds to step 710. In step 709, the UE performs an operation of receiving the MBMS service joined by the UE on a PtP basis. If the UE determines in step 710 that the MBMS service joined by the UE is not provided based on the IE Transfer mode, it performs in step 711 an operation of receiving the MBMS service joined by the UE in the current cell in which the UE is located. If the IE Transfer mode does corresponds to none of PtM, PtP and no-RB, the UE proceeds to step 712, determining that there is an error.

In any one of steps 712 to 714, the UE checks the IEs necessary for the MBMS Notification Info message. In step 712, the UE checks the IE Preferred frequency included in the MBMS Service List message to acquire the information on a frequency at which the MBMS service joined by the UE is provided. In step 713, the UE checks the IE continue MCCH reading to determine if it should continuously receive control information transmitted over an MCCH. In step 714, the UE checks the IE Common RB value tag to determine if it is necessary to receive an MBMS Common RB Info message. In step 715, the UE performs a required operation based on information acquired from the MBMS Service List message. Herein, the “required operation” refers to an operation of receiving succeeding control information messages or storing required information.

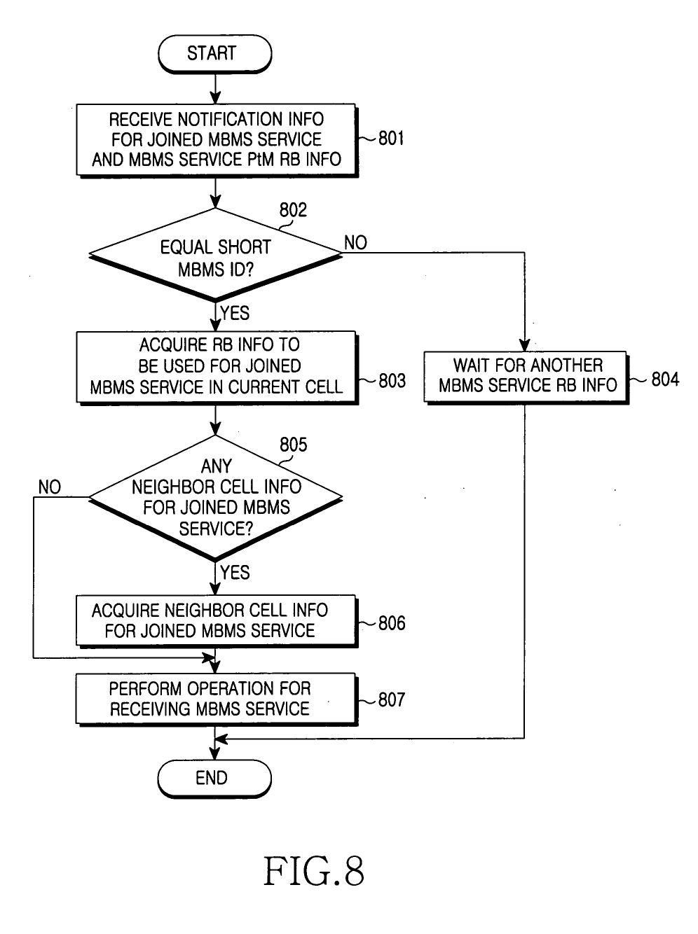

FIG. 8 is a flowchart describing an operation of receiving an MBMS Service PtM RB Info message by a UE according to a preferred embodiment of the present invention. Referring to FIG. 8, after receiving an MBMS Notification Info message for an MBMS service joined by a UE, the UE receives an MBMS Service PtM RB Info message over an MCCH in step 801. In step 802, the UE determines if a Short MBMS ID acquired from the MBMS Notification Info message is equal to an IE Short MBMS ID included in the MBMS Service PtM RB Info message. If the MBMS IDs are not equal to each other, the UE proceeds to step 804 where it waits for another MBMS Service PtM RB Info message.

However, if the IDs are equal to each other in step 802, it means that there is RB information for the joined MBMS service in the MBMS Service PtM RB Info message. In step 803, the UE acquires the current cell RB information for the joined MBMS service from the MBMS Service PtM RB Info message. In step 805, the UE determines if there is information on a neighbor cell for the joined MBMS service. If there is information on a neighbor cell for the joined MBMS service, the UE acquires the information on a neighbor cell for the joined MBMS service in step 806, and otherwise, performs an operation of receiving the MBMS service in step 807. In step 806, the UE can acquire the neighbor cell information by receiving a separate MBMS Neighboring Cell PtM RB Info message. In step 807, the “operation of receiving the MBMS service” refers to an operation of setting up an RB and a physical channel used for receiving the MBMS service, based on the acquired RB information.

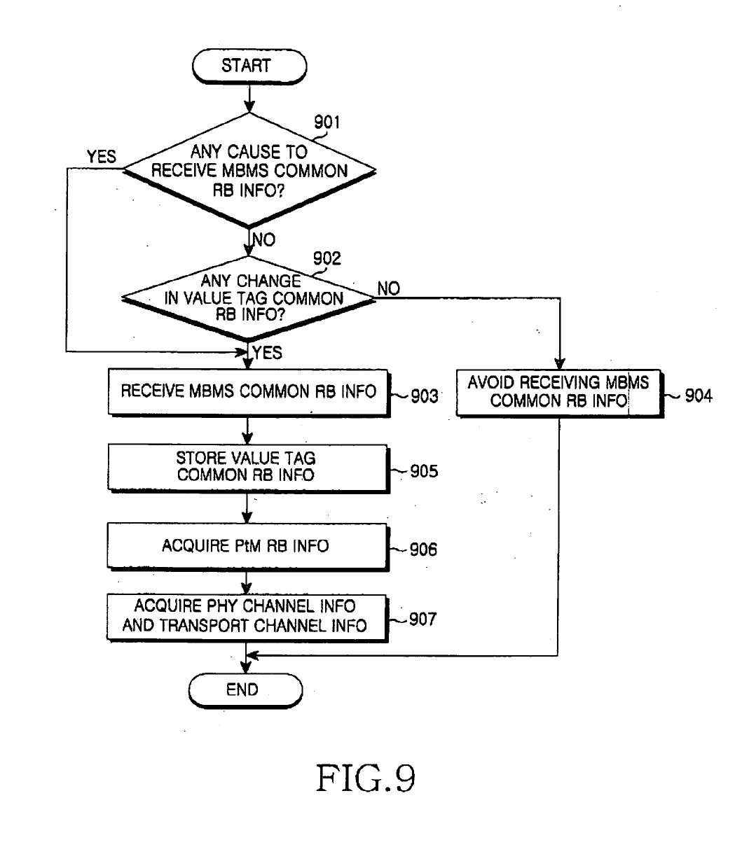

FIG. 9 is a flowchart illustrating an operation of receiving an MBMS Common RB Info message by a UE according to a preferred embodiment of the present invention. Referring to FIG. 9, in step 901, a UE determines if there is a cause to receive an MBMS Common RB Info message. An example of the cause to receive the MBMS Common RB Info message corresponds to a case where the UE shifts to a new cell or a new frequency. If there is any cause to receive the MBMS Common RB Info message in step 901, the UE proceeds to step 903. However, if there is no cause to receive the MBMS Common RB Info message in step 901, the UE proceeds to step 902.

In step 902, the UE determines if a value tag stored in the UE is equal to a value tag included in other control information messages that the UE has previously received. If the value tag values are equal to each other, the UE proceeds to step 904 where it ends the operation without receiving the MBMS Common RB Info message.

However, if the value tag values are not equal to each other, the UE receives an MBMS Common RB Info message through an MCCH in step 903, and stores a value tag included in the MBMS Common RB Info message in step 904. In step 906, the UE acquires RB information included in the MBMS Common RB Info message received in step 903. In step 907, the UE acquires the physical channel information and the transport channel information from the MBMS Common RB Info message. The received RB information and physical channel/transport channel information are stored, preparing for the case where the UE sets up an RB to receive a corresponding MBMS service therethrough.

As described above, the present invention proposes a method for defining the control information messages transmitted over an MCCH, and minimizing a signaling overhead during the transmission of the defined control information messages. In addition, the present invention proposes a method for efficiently scheduling the control information messages before the transmission. In this manner, a UE receiving the control information messages can prevent duplicate reception of the same information elements and prevent an MCCH from being continuously received, thereby minimizing power consumption of the UE.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting control information for supporting a Multimedia Broadcast/Multicast Service (MBMS) service in a mobile communication system providing the MBMS service, the method comprising:
generating an MBMS notification information message for indicating a change in an MBMS service; and
transmitting the MBMS notification information message to at least one user equipment (UE) located in a cell capable of providing the MBMS service,
wherein the MBMS notification information message includes an MBMS service identifier (ID), a cause value indicating the cause for the notification, frequency information for the MBMS service, and continue reading information indicating whether to continuously receive control information messages transmitted after the MBMS notification information message.

2. A method for receiving control information for supporting a Multimedia Broadcast/Multicast Service (MBMS) service in a mobile communication system providing the MBMS service, the method comprising:
receiving a notification indicator (NI) for an MBMS service;
if the received notification indicator is affirmative, determining if a current frame corresponds to a start time of a predetermined modification period (MP);
if the current frame arrives at the start time of the modification period, receiving an MBMS notification information message indicating a change in the MBMS service, the MBMS notification information message includes an MBMS service identifier (ID), a cause value indicating the cause for the notification, frequency information for the MBMS service, and continue reading information indicating whether to continuously receive control information messages transmitted after the MBMS notification information message; and
checking the cause value of the MBMS notification information message, and performing an operation according to the cause value.

3. The method of claim 2, further comprising:
if the cause value represents a point-to-multipoint (PtM) radio bearer (RB) change for the MBMS service, changing an RB for the MBMS service to a PtM RB;
if the cause value represents a PtM RB release for the MBMBS service, releasing a PtM RB for the MBMS service; and
if the cause value represents the PtM RB change but does not represent the PtM RB release, checking the frequency information and the continue reading information in the MBMS notification information message.

4. The method of claim 3, further comprising, if the continue reading information represents continuous reception of succeeding control information messages, receiving at least one of an MBMS service list message including control information for at least one MBMS service of a current cell, an MBMS common RB information message including common control information for RBs, physical channels and transport channels used for MBMS services provided in the current cell, and an MBMS point-to-multipoint (PtM) RB information message including control information for MBMS services provided in the current cell and neighbor cells.

5. A method for transmitting control information for supporting a Multimedia Broadcast/Multicast Service (MBMS) service in a mobile communication system providing the MBMS service, the method comprising:
generating an MBMS service list message including control information for at least one MBMS service of a current cell; and
transmitting the MBMS service list message to at least one user equipment (UE) located in the current cell,
wherein the MBMS service list message includes an MBMS service identifier (ID), information indicating a transfer mode of a corresponding MBMS service, and frequency information for the corresponding MBMS service.

6. A method for receiving control information for supporting a Multimedia Broadcast/Multicast Service (MBMS) service in a mobile communication system providing the MBMS service, the method comprising:
determining if a current frame corresponds to a start time of a repetition period (RP), if an MBMS service list message including control information for at least one MBMS service of a current cell is to be received;
if the current frame arrives the start time of the repetition period, receiving the MBMS service list message, the MBMS service list message includes an MBMS service identifier (ID), information indicating a transfer mode for a corresponding MBMS service, and frequency information for the corresponding MBMS service;
determining if there is an ID of a joined MBMS service in the MBMS service list message;
checking a transfer mode of the joined MBMS service, if there is an ID of the joined MBMS service in the MBMS service list message; and
performing an operation of receiving the joined MBMS service based on whether the transfer mode of the joined MBMS service corresponds to a point-to-multipoint (PtM), a point-to-point (PtP), or a no-RB (radio bearer).

7. The method of claim 6, further comprising checking the frequency information in the MBMS service list message if the transfer mode one of corresponds to the PtM and does not correspond to one of the PtM, PtP and no-RB.

8. A method for transmitting control information for supporting a Multimedia Broadcast/Multicast Service (MBMS) service in a mobile communication system providing the MBMS service, the method comprising:
generating an MBMS common radio bearer (RB) information message including common control information for RBs, physical channels and transport channels used for MBMS services provided in a current cell; and
transmitting the MBMS common RB information message to at least one user equipment (UE) located in the current cell,
wherein the MBMS common RB information message includes an RB information list for RBs commonly used by the MBMS services, transport channel information and physical channel information.

9. A method for receiving control information for supporting a Multimedia Broadcast/Multicast Service (MBMS) service in a mobile communication system providing the MBMS service, the method comprising:
receiving an MBMS common radio bearer (RB) information message, if the MBMS common RB information message including common control information for RBs, physical channels and transport channels used for MBMS services provided in a current cell, it is to be received, the MBMS common RB information message includes an RB information list for RBs commonly used by the MBMS services, transport channel information and physical channel information; and
acquiring the RB information list, the transport channel information and the physical channel information, all of which are included in the MBMS common RB information message.

10. A method for transmitting control information for supporting a Multimedia Broadcast/Multicast Service (MBMS) service in a mobile communication system providing the MBMS service, the method comprising:
generating an MBMS service point-to-multipoint (PtM) radio bearer (RB) information message including control information for MBMS services provided in a current cell and neighbor cells; and
transmitting the MBMS service PtM RB information message to at least one user equipment (UE) located in the current cell,
wherein the MBMS service PtM RB information message includes current cell RB information including an RB information list for RBs used by MBMS services provided in the current cell, transport channel information and physical channel information, and neighbor cell RB information including an RB information list for RBs used by MBMS services provided in the neighbor cells, transport channel information and physical channel information.

11. A method for receiving control information for supporting a Multimedia Broadcast/Multicast Service (MBMS) service in a mobile communication system providing the MBMS service, the method comprising:
receiving an MBMS notification information message for notifying a significant change in an MBMS service, and receiving an MBMS service point-to-multipoint (PtM) radio bearer (RB) information message including control information for MBMS services provided in a current cell and neighbor cells according to the MBMS notification information message;
determining if there is RB information for a joined MBMS service in the MBMS service PtM RB information message; and
if there is RB information for the joined MBMS service, acquiring control information for the current cell and the neighbor cells for the joined MBMS service from the MBMS service PtM RB information message.

12. The method of claim 11, wherein if an identifier (ID) of the joined MBMS service is included in the MBMS service PtM RB information message, it is determined that there is RB information.
